(19) United States
(12) Patent Application Publication
(10) Pub. No.: US 2004/0239610 A1
(43) Pub. Date: Dec. 2, 2004

(54) Electro-optical panel driving circuit, electro-optical device provided with electro-optical panel and driving circuit, and electronic apparatus provided with electro-optical device

(75) Inventor: Kenya Ishii, Fujimi-cho (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/825,305

(22) Filed: Apr. 16, 2004

(30) Foreign Application Priority Data
May 12, 2003 (JP) 2003-133278
Feb. 20, 2004 (JP) 2004-044661

(51) Int. Cl. H04N 11/02; G09G 3/36

(52) U.S. Cl. 345/100

(57) ABSTRACT

An electro-optical panel driving circuit is provided on a substrate and includes a shift register circuit that sequentially outputs transfer signals, a buffer circuit that buffers the sequentially output transfer signals, a sampling circuit that samples image signals using the buffered transfer signals as sampling pulses and that supplies the sampled image signals to data lines, and a dummy circuit that simulates at least part of the buffer circuit and the sampling circuit. Delay signals indicating the amount of delay of the sampling pulses and generated by the dummy circuit are fed back to the shift register circuit so that the amount of delay is reduced. The buffer circuit, the sampling circuit, and the dummy circuit are provided on the substrate.

### BACKGROUND OF THE INVENTION

1. Field of Invention

The present invention relates to driving circuits to drive electro-optical panels, such as liquid crystal panels, to electro-optical devices, such as liquid crystal devices, provided with such electro-optical panels and driving circuits, and to electronic apparatus, such as liquid crystal projectors, provided with such electro-optical devices.

2. Description of Related Art

For example, a sampling circuit to sample image signals and to supply the sampled image signals to data lines of an electro-optical panel and a data line driving circuit to supply sampling pulses to the sampling circuit are included in a driving circuit of electro-optical panels of this type. The data line driving circuit sequentially outputs transfer signals output from a shift register, as sampling pulses, to the sampling circuit via a buffer circuit. The buffer circuit buffers the transfer signals output from the shift register and the sampling circuit samples image signals in image signal lines by using the buffered transfer signals as sampling pulses and supplies the sampled image signals to the data lines.

In the driving circuit with such an arrangement, generally, transfer signals are output from the shift register in synchronization with a clock cycle of clock signals supplied to the data line driving circuit. Thus, under the influence of signal delay in the buffer circuit or the sampling circuit of the driving circuit, a delay with respect to the clock signals occurs in the sampling pulses. This delay in the sampling pulses is not a negligible amount.

Thus, for example, a technology to measure a delay time in sampling pulses in a buffer circuit and a sampling circuit provided in a panel and to adjust the timing of clock signals input to a data line driving circuit was developed by the inventor(s). Specifically, a dummy circuit that simulates the buffer circuit and the sampling circuit is installed on a substrate of an electro-optical panel as an external integrated circuit (IC). Also, a timing adjusting circuit to measure a delay time by counting pulses output from the dummy circuit and to adjust the timing of the clock signals on the basis of the measured delay time is installed on the substrate of the electro-optical panel as an external IC. Accordingly, by indirectly measuring the delay time, the timing of the clock signals input to the data line driving circuit can be adjusted on the basis of the measured results.

However, according to the technology described above, the output of the dummy circuit does not accurately reflect the characteristics of the sampling circuit and the buffer circuit. Thus, high accuracy cannot be achieved by the indirect measurement of a delay time by such a dummy circuit. Therefore, there is a technological problem in that the adverse influence of delay cannot be fully eliminated by timing adjustment based on such measurement results. Furthermore, according to a technology disclosed in Japanese Unexamined Patent Publication No. 11-119746 since a dummy circuit uses an internal power supply of an electro-optical panel, the dummy circuit is restricted by the voltage of the internal power supply. Thus, there is a technological problem in that, generally, high breakdown voltage characteristics are required for an IC constituting the dummy circuit.

### SUMMARY OF THE INVENTION

In order to address the above problems, the present invention provides an electro-optical panel driving circuit capable of reducing or eliminating the adverse influence of delay of sampling pulses occurring in the electro-optical panel driving circuit relatively easily and with high accuracy, an electro-optical device provided with the driving circuit and the electro-optical panel, and an electronic apparatus provided with the electro-optical device.

In order to achieve the above, an electro-optical panel driving circuit to drive an electro-optical panel including pixel electrodes, switching elements that switch on and off the corresponding pixel electrodes, and data lines that supply image signals to the corresponding pixel electrodes via the corresponding switching elements provided above a substrate, includes a shift register circuit that sequentially outputs transfer signals; a buffer circuit that buffers the sequentially output transfer signals; a sampling circuit that samples the image signals using the buffered transfer signals as sampling pulses and that supplies the sampled image signals to the corresponding data lines; and a dummy circuit that simulates at least part of the buffer circuit and the sampling circuit. Delay signals indicating the amount of delay of the sampling pulses and generated by the dummy circuit are fed back to the shift register circuit so that the amount of delay is reduced. The buffer circuit, the sampling circuit, and the dummy circuit are provided on the substrate.

According to the electro-optical panel driving circuit of an aspect of the present invention, image signals are sampled in the sampling circuit in accordance with sampling pulses output from the shift register circuit via the buffer circuit when the driving circuit is operating. Accordingly, the sampled image signals are supplied to the corresponding data lines. Then, the image signals supplied via the corresponding data lines are supplied to the corresponding pixel electrodes via the corresponding switching elements, which are thin-film transistors (hereinafter, “TFTs”) or the like, in accordance with, for example, scanning signals separately supplied via scanning lines. Thus, image display based on active matrix driving can be achieved.

During such an operation, the dummy circuit that simulates at least part of the buffer circuit and the sampling circuit generates delay signals indicating the amount of delay of the sampling pulses. The delay signals are fed back to the shift register circuit so that the amount of delay of the sampling pulses is reduced. Thus, the adverse influence of the delay of the sampling pulses upon a display image can be reduced in accordance with the degree of simulation of the buffer circuit and the sampling circuit by the dummy circuit. Specifically, in accordance with how well the characteristics of the sampling circuit are simulated by the characteristics of the dummy circuit. Since the buffer circuit, the sampling circuit, and the dummy circuit are provided on the substrate constituting the electro-optical panel, for example, the dummy circuit can be formed in the same process and at the same time as the buffer circuit and the sampling circuit when the electro-optical panel is manufactured. Alternatively, the channel width of the TFTs and the like constituting each of the buffer circuit, the sampling circuit, and the dummy circuit may be equal to each other. Accordingly, the degree of simulation by the dummy circuit can be easily increased.

As a result of this, the adverse influence of delay of the sampling pulses upon image display can be reduced or eliminated relatively easily and with high accuracy.

In an aspect of the electro-optical panel driving circuit according to the present invention, the shift register circuit may be provided in an integrated circuit externally attached to the substrate.

According to this aspect, the shift register circuit can be mounted on the substrate relatively easily as an IC attached externally or attached later. In contrast, since the dummy circuit is formed on the same substrate as the buffer circuit and the sampling circuit simulated by the dummy circuit, the degree of simulation by the dummy circuit can be increased as described above.

In another aspect of the electro-optical panel driving circuit according to the present invention, the buffer circuit may include a plurality of stages of buffers connected in series. The sampling circuit may include analog sampling switches. The dummy circuit may simulate at least the buffer in the final stage among the plurality of stages of buffers.

According to this aspect, the dummy circuit simulates the buffer in the final stage among the plurality of stages of buffers constituting the buffer circuit, the delay constraints of the sampling pulses of the buffer in the final stage being relatively high. Thus, the degree of simulation by the dummy circuit can be effectively increased. For example, the buffer circuit includes one or more inverters. In particular, the inverter constituting the buffer in the final stage is arranged such that the current ratio of an input side to an output side is as high as approximately 1:20. Since such an inverter in the final stage is simulated by the dummy circuit, the amount of delay of the sampling pulses can be effectively detected with high accuracy. In particular, if it is difficult to form a dummy circuit simulating the entire buffer circuit and the sampling circuit on the limited space on the substrate, simulating only the buffer in the final stage is very effective.

In this aspect, the dummy circuit may simulate the sampling switches and all of the plurality of stages of buffers.

With this structure, the degree of simulation by the dummy circuit is very high, and the adverse influence of the delay of the sampling pulses can thus be significantly reduced or eliminated.

In another aspect of the electro-optical panel driving circuit according to the present invention, semiconductor elements constituting the sampling circuit may be formed in the same process and at the same time as semiconductor elements constituting the corresponding dummy circuit.

According to this aspect, the semiconductor elements, such as TFTs, constituting the sampling circuit, are formed on the same substrate, in the same process, and at the same time as the semiconductor elements, such as TFTs, constituting the corresponding dummy circuit. Thus, the circuit characteristics of the sampling circuit can be simulated by the circuit characteristics of the dummy circuit with very high accuracy. Specifically, the degree of simulation can be significantly increased.

In this aspect, each of the semiconductor elements may be an N-type semiconductor element.

With this structure, the buffer circuit and the sampling circuit can be formed by N-type semiconductor elements with excellent carrier mobility. Also, when such semiconductor elements are formed, a dummy circuit with the same or similar characteristics can be formed at the same time. In particular, it is advantageous for an analog sampling switch to use such an N-type semiconductor element with excellent carrier mobility. However, use of a P-type semiconductor element can also increase the degree of simulation by the dummy circuit. Thus, a similar advantage according to an aspect of the present invention can be achieved in terms of reducing the adverse influence of delay of the sampling pulses.

In an aspect of such semiconductor elements, each of the semiconductor elements may be a thin-film transistor. The source of the thin-film transistor may be connected to a low-potential power supply of the driving circuit. The drain of the thin-film transistor may be biased at a high-potential power supply of the driving circuit and be connected to a detection terminal of the driving circuit. The shift register circuit may sequentially output the transfer signals in accordance with a clock cycle of clock signals. The electro-optical panel driving circuit may further include a timing adjusting circuit to adjust the timing of the clock signals input to the shift register circuit on the basis of the timing of the falling edge of the delay signals detected by the detection terminal.

With this structure, the source of the thin-film transistor is connected to the low-potential power supply of the driving circuit. In contrast, the drain of the thin-film transistor is biased at the high-potential power supply of the driving circuit and is connected to the detection terminal. These power supplies cause the dummy circuit to operate. In particular, since the timing of the clock signals is adjusted on the basis of the timing of the falling edge of the delay signals detected by the detection terminal, the amount of delay of the sampling pulse can be detected with very high accuracy and the corresponding adjustment can be performed. Furthermore, the biased detection terminal is, for example, connected to the high-potential power supply with an appropriate resistor therebetween. Thus, the breakdown voltage characteristics required for the thin-film transistor constituting the dummy circuit can be reduced, and this is very important from a practical point of view.

Alternatively, in another aspect of the electro-optical panel driving circuit according to the present invention, the shift register circuit may sequentially output the transfer signals in accordance with a clock cycle of clock signals. The electro-optical panel driving circuit may further include a timing adjusting circuit to adjust the timing of the clock signals input to the shift register circuit on the basis of the amount of delay indicated by the delay signals.

According to this aspect, the shift register circuit sequentially outputs the transfer signals in accordance with the clock cycle of the clock signals. Accordingly, sampling is performed by the sampling circuit and the like. Then, in accordance with the delay of the sampling pulses with respect to the clock signals, the timing adjusting circuit adjusts the timing of the clock signals. Consequently, the delay of the sampling pulses can be very effectively reduced by the adjustment of the clock signals by feedback control.

In this aspect, the shift register circuit and the timing adjusting circuit may be provided in an integrated circuit externally attached to the substrate.

With this structure, the shift register circuit and the timing adjusting circuit can be mounted on the substrate relatively easily as an IC attached externally or attached later. In contrast, since the dummy circuit is formed on the same substrate as the buffer circuit and the sampling circuit simulated by the dummy circuit, the degree of simulation by the dummy circuit can be increased as described above.

In another aspect of the electro-optical panel driving circuit according to the present invention, the channel width of first thin-film transistors constituting the sampling circuit may be equal to the channel width of second thin-film transistors constituting the dummy circuit, the second thin-film transistors corresponding to the first thin-film transistors.

According to this aspect, the channel width of the thin-film transistors of the sampling circuit may be equal to the channel width of the corresponding thin-film transistors of the dummy circuit. Thus, the degree of simulation by the dummy circuit can be significantly increased.

In another aspect of the electro-optical panel driving circuit according to the present invention, the channel width of second thin-film transistors constituting the dummy circuit, the second thin-film transistors corresponding to first thin-film transistors constituting the sampling circuit, may be smaller than or equal to the channel width of the first thin-film transistors. Also, the ratio of the size of the first thin-film transistors to the size of a first buffer circuit in the preceding stage of the first thin-film transistors may be equal to the ratio of the size of the second thin-film transistors of the dummy circuit to the size of a second buffer circuit in the preceding stage of the second thin-film transistors.

According to this aspect, the channel width of the thin-film transistors of the dummy circuit, the thin-film transistors corresponding to the thin-film transistors of the sampling circuit, is smaller than or equal to the channel width of the thin-film transistors of the sampling circuit. Thus, in a case where there is little space or no space on the limited substrate to form the dummy circuit, forming a compact dummy circuit avoids the problem of space shortage. Alternatively, miniaturization of the substrate and the entire electro-optical panel, including an area required to form a dummy circuit, is achieved. Furthermore, the ratio of the size of the thin-film transistors of the sampling circuit to the size of the first buffer circuit is equal to the ratio of the size of the corresponding thin-film transistors of the dummy circuit to the second buffer circuit. Thus, even if the dummy circuit is miniaturized as compared with the circuit to be simulated, the degree of simulation is generally kept high.

In another aspect of the electro-optical panel driving circuit according to the present invention, the buffer circuit may include a plurality of stages of buffers connected in series. The sampling circuit may include analog sampling switches. The channel width of second thin-film transistors constituting the dummy circuit, the second thin-film transistors corresponding to first thin-film transistors functioning as the sampling switches, may be smaller than or equal to the channel width of the first thin-film transistors. The ratio of the size of the first thin-film transistors to the size of the buffer in the final stage of the first buffer circuit in the preceding stage of the first thin-film transistors may be equal to the ratio of the size of the second thin-film transistors of the dummy circuit to the size of the buffer in the final stage of a second buffer circuit in the preceding stage of the second thin-film transistors.

According to this aspect, the channel width of the thin-film transistors of the dummy circuit, the thin-film transistors corresponding to the thin-film transistors functioning as the sampling switches, is smaller than or equal to the channel width of the thin-film transistors functioning as the sampling switches. Thus, in a case where there is little space or no space on the limited substrate to form the dummy circuit, forming a compact dummy circuit avoids the problem of space shortage. Alternatively, miniaturization of the substrate and the entire electro-optical panel, including an area required to form a dummy circuit, is achieved. Furthermore, the ratio of the size of the thin-film transistors functioning as the sampling switches to the size of the buffer in the final stage is equal to the ratio of the size of the corresponding thin-film transistors of the dummy circuit to the buffer in the final stage. Thus, even if the dummy circuit is miniaturized as compared with the circuit to be simulated, the degree of simulation is generally kept high. In particular, since the analog sampling switches and the buffer in the final stage in which the delay constraints of sampling pulses are relatively high are simulated, the degree of simulation by the dummy circuit can be effectively increased.

In order to achieve the above, an electro-optical device according to an aspect of the present invention includes the electro-optical panel driving circuit according to an aspect of the present invention (including each aspect) and the electro-optical panel.

Since the electro-optical device according to an aspect of the present invention includes the electro-optical panel driving circuit according to an aspect of the present invention, the adverse influence of delay of the sampling pulses is reduced. Thus, image display with high quality can be achieved.

In order to achieve the above, an electronic apparatus according to an aspect of the present invention includes the electro-optical device according to an aspect of the present invention (including each aspect).

Since the electronic apparatus according to the present invention includes the electro-optical device according to an aspect of the present invention, various electronic apparatus, such as a projection type display device, a liquid crystal television set, a mobile telephone, an electronic notebook, a word processor, a view-finder type or monitor direct-view type video tape recorder, a workstation, a television telephone, a POS terminal, and a touch panel, are capable of displaying images with high quality. Also, an electrophoretic device, such as electronic paper, can be realized as the electronic apparatus according to an aspect of the present invention.

Such operations and other advantages according to an aspect of the present invention will be apparent from embodiments described below.

### BRIEF DESCRIPTION OF THE DRAWINGS

FIG. 1 is a schematic showing the entire structure of a liquid crystal device according to an aspect of the present invention;

FIG. 2 is a logic circuit schematic showing the details of a data line driving circuit 150 and a sampling circuit 140 according to a first exemplary embodiment;

FIG. 3 is a timing chart showing the state of main signals in the logic circuit schematic shown in FIG. 2;

FIG. 4 is a circuit schematic showing the structure of a timing generator;

FIGS. 5a-5c include circuit schematics: FIG. 5a showing the structure of a dummy circuit 27a according to a working example, which is the structure of a dummy circuit 27 according to the first exemplary embodiment shown in FIG. 2; FIG. 5b showing the structure of a dummy circuit 27b according to comparative example 1; and FIG. 5c showing the structure of a dummy circuit 27c according to comparative example 2;

FIG. 6 includes timing charts showing the detection state of signal delay in the dummy circuit 27a according to the working example, in the dummy circuit 27b according to comparative example 1, and the dummy circuit 27c according to comparative example 2;

FIG. 7 is a logic circuit schematic showing the details of the data line driving circuit 150 and the sampling circuit 140 according to a third exemplary embodiment;

FIG. 8 is a schematic showing the entire structure of the liquid crystal device;

FIG. 9 is a cross-sectional schematic taken along the plane H-H′ of FIG. 8;

FIG. 10 is a schematic showing the structure of an electronic apparatus according to an aspect of the present invention;

FIG. 11 is a cross-sectional schematic showing a liquid crystal projector as an example of the electronic apparatus;

FIG. 12 is a schematic showing a personal computer as another example of the electronic apparatus; and

FIG. 13 is a schematic showing a liquid crystal device using a TCP as an example of the electronic apparatus.

### DETAILED DESCRIPTION OF EXEMPLARY EMBODIMENTS

Exemplary embodiments of the present invention will be described with reference to the drawings. In the exemplary embodiments described below, an electro-optical device according to an aspect of the present invention is applied to a TFT active-matrix-drive-type liquid crystal device.

First Exemplary Embodiment

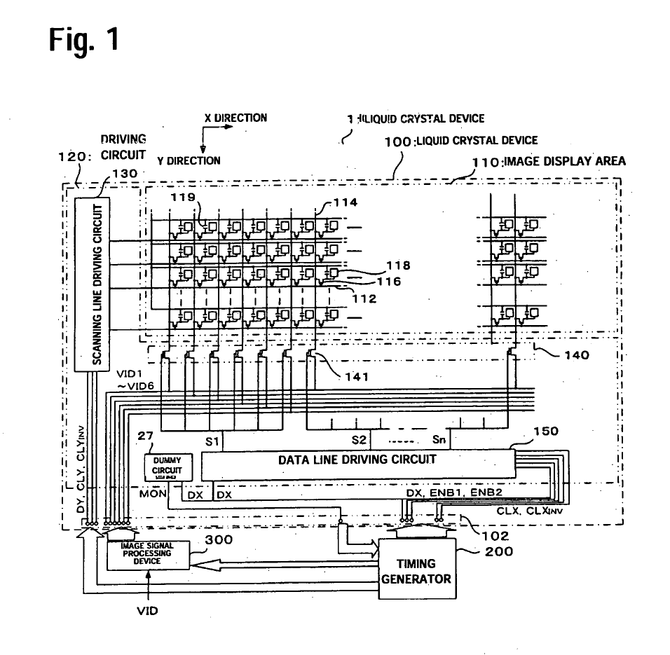

An electro-optical device according to a first exemplary embodiment of the present invention will now be described with reference to FIGS. 1 to 5.

The entire structure of the electro-optical device according to an aspect of the present invention will be described with reference to FIG. 1. FIG. 1 is a schematic showing the entire structure of a liquid crystal device 1 according to the first exemplary embodiment.

Referring to FIG. 1, the liquid crystal device 1 includes, as a main part, a liquid crystal panel 100, which is an example of an electro-optical panel according to an aspect of the present invention, a timing generator 200, and an image signal processing circuit 300.

The liquid crystal panel 100 has a device substrate, provided with TFTs 116 functioning as switching elements, and an opposing substrate. The device substrate and the opposing substrate are attached to each other with a predetermined space therebetween such that sides on which electrodes are mounted face each other, and liquid crystal is held in the space. The timing generator 200 outputs various timing signals used in each part. A timing signal output device, which is a part of the timing generator 200, creates a dot clock. The dot clock is the smallest unit of clock and is used for scanning of each pixel. A transfer start pulse DX and a transfer clock CLX are created on the basis of the dot clock. The image signal processing circuit 300 serial-to-parallel converts an input single-system image signal VID into six-phase image signals VID1 to VID6 and outputs the converted image signals VID1 to VID6.

In the first exemplary embodiment, in particular, the liquid crystal panel 100 contains a driving circuit. A driving circuit 120 including a scanning line driving circuit 130, a sampling circuit 140, and a data line driving circuit 150 is provided on the device substrate thereof. The liquid crystal panel 100 also includes a dummy circuit 27.

Although the dummy circuit 27 is illustrated as one block in the schematic in FIG. 1, the actual structure and operation will be described below.

The liquid crystal panel 100 also includes data lines 114 and scanning lines 112 arranged vertically and horizontally, respectively, in an image display area 110 arranged in the center of the device substrate. Pixel electrodes 118 arranged in a matrix and the TFTs 116 to switch on and off the pixel electrodes 118 are provided at pixels corresponding to the intersections of the data lines 114 and the scanning lines 112. Also, the image signals VID1 to VID6 are sampled by the sampling circuit 140 in accordance with sampling signals S1, S2, . . . ,Sn supplied from the data line driving circuit 150 and are supplied to the data lines 114.

The source electrode of each of the TFTs 116 is electrically connected to the corresponding data line 114 to which the image signal is supplied. The gate electrode of each of the TFTs 116 is electrically connected to the corresponding scanning line 112 to which a scanning signal is supplied. The drain electrode of each of the TFTs 116 is connected to the corresponding pixel electrode 118. Each pixel includes the pixel electrode 118, a common electrode provided on the opposing substrate, and the liquid crystal sandwiched between the electrodes. Thus, pixels are arranged in a matrix corresponding to the intersections of the scanning lines 112 and the data lines 114.

In order to reduce or prevent leakage of the held image signals, storage capacitors 119 are added in parallel to liquid crystal capacitors arranged between the respective pixel electrodes 118 and counter electrodes. For example, the voltage of the pixel electrodes 118 is maintained by the storage capacitors 119 for a period of time three orders of magnitude longer than a period of time for which the source voltage is applied, thus enhancing the hold characteristics. Consequently, a high contrast ratio can be realized.

The driving circuit 120 includes the scanning line driving circuit 130, the sampling circuit 140, and the data line driving circuit 150 in an area near the image display area 110. Active elements of the circuits can be formed by the combination of a P-channel TFT and an N-channel TFT. Thus, forming the active elements in the circuits in the same manufacturing process as the TFTs 116, which switch on and off the respective pixels, is advantageous in increasing the density, reducing the manufacturing cost, making the elements uniform, and so on.

The scanning line driving circuit 130 of the driving circuit 120 includes a shift register. The scanning line driving circuit 130 sequentially outputs scanning signals to the scanning lines 112 in accordance with a clock signal CLY, an inversion clock signal CLY_{INV}, a transfer start pulse DY, and the like supplied from the timing generator 200.

In the first exemplary embodiment, in particular, a buffer circuit is provided in a part of the data line driving circuit 150 that is arranged on the device substrate or in an area between a shift register of the data line driving circuit 150 and the sampling circuit 140, although the buffer circuit is not illustrated in FIG. 1. The buffer circuit buffers transfer signals output from the shift register of the data line driving circuit 150 and outputs the buffered transfer signals as sampling pulses to control terminals (specifically, gate terminals of the first-conductivity-type TFTs in FIG. 1) of the sampling circuit 140. Also, the dummy circuit 27, which simulates at least part of the buffer circuit and the sampling circuit 140, is provided on the device substrate. The structure and operation of the buffer circuit and the dummy circuit 27 will be described below.

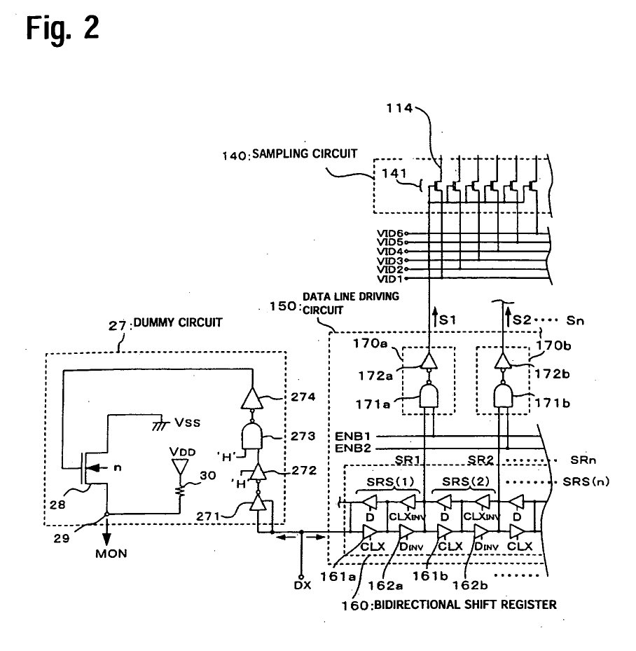

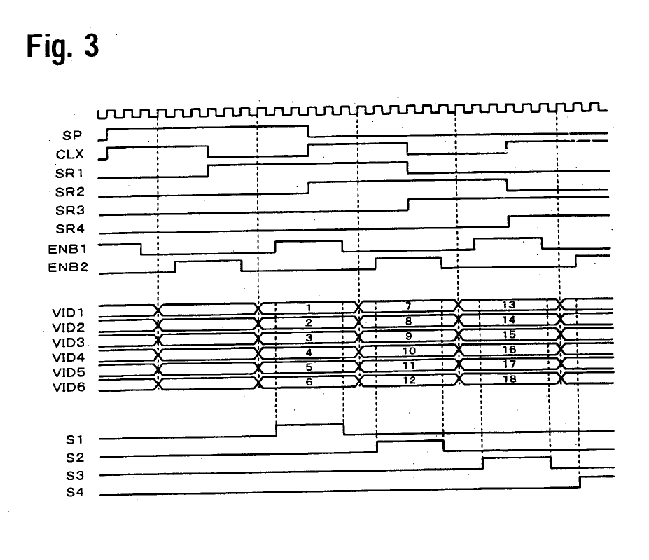

The structure and operation of the sampling circuit 140 and the data line driving circuit 150 according to the first exemplary embodiment will now be described with reference to FIGS. 2 and 3. FIG. 2 is a schematic showing the details of the sampling circuit 140 and the data line driving circuit 150 according to the first exemplary embodiment. FIG. 3 is a timing chart showing the time-lapse change of various signals relating to the sampling circuit 140 and the data line driving circuit 150.

As shown in FIG. 2, in the first exemplary embodiment, the data line driving circuit 150 includes a bi-directional shift register 160 to sequentially drive the data lines 114 bi-directionally. The shift direction is determined by a direction control signal D. If the direction control signal D is high, the transfer start pulse DX is input to the bi-directional shift register 160 from the left. The transfer start pulse DX is sequentially shifted from left to right and is output as transfer signals SR1 to SRn from the corresponding stages SRS(i), where i represents 1, 2, 3, . . . , n, of the bi-directional shift register 160. Here, if an inverse direction control signal D_{INV} is positive, the transfer start pulse DX is input to the bi-directional shift register 160 from the right and is sequentially shifted from right to left.

Enable circuits 170a and 170b constituting an example of the buffer circuit according to an aspect of the present invention are arranged between the bi-directional shift register 160 and the sampling circuit 140. The enable circuit 170a includes a NAND circuit 171a and an inverter 172a. The enable circuit 170b includes a NAND circuit 171b and an inverter 172b.

The transfer signals SR1 to SRn output from the bi-directional shift register 160 are supplied to one input of the enable circuits 170a, 170b, and so on, respectively. Enable signals ENB1 and ENB2 are input to the other input of the enable circuits 170a and 170b, respectively. Thus, the data lines 114 are driven only when the corresponding transfer signals SR1 to SRn are output and the corresponding enable signals ENB1 and ENB2 are output. The enable signals ENB1 and ENB2 control the corresponding data lines 114 to an active state when the image signal VID is output stably.

After being logically multiplied by enable signals by the enable circuits 170a, 170b, and so on, the transfer signals SR1 to SRn are supplied as data line driving signals or sampling circuit driving signals (hereinafter, referred to as sampling signals) S1 to Sn, which are an example of sampling pulses according to an aspect of the present invention, to the sampling circuit 140. The sampling circuit 140 includes a plurality of sampling switches 141 each including a first-conductivity-type TFT used for sampling. Six data lines 114 constitute each group. For the data lines 114 belonging to each group, the six-phase serial-to-parallel converted image signals VID1 to VID6 are sampled in accordance with the sampling signals S1 to Sn and are sequentially output to the corresponding data lines 114. In more detail, in the sampling circuit 140, one end of each of the data lines 114 is provided with the sampling switch 141. Also, a source electrode of each of the sampling switches 141 is connected to a signal line to which one of the image signals VID1 to VID6 is supplied and a drain electrode of each of the sampling switches 141 is connected to one of the data lines 114. Also, a gate electrode of each of the sampling switches 141 is connected to a signal line to which the corresponding one of the sampling signals S1 to Sn is supplied in accordance with the group. In the first exemplary embodiment, since the image signals VID1 to VID6 are supplied at the same time, they are sampled by the sampling signal S1 at the same time.

If the timing of supply of the image signals VID1 to VID6 is equal to the timing of the sequential shift, the image signals VID1 to VID6 are sequentially sampled by the sampling signals S1, S2, . . . , Sn.

As shown in the timing chart of FIG. 3, by the data line transfer clock CLX (hereinafter, a transfer clock CLX) and its inversion clock signal CLX_{INV}, the transfer start pulse DX input to the bi-directional shift register 160 is shifted for every half cycle of the transfer clock CLX, and data line transfer signals (hereinafter, transfer signals) SRI to SRn, which are delayed by a half cycle of the transfer clock CLX, are sequentially output from the corresponding output stages of the bi-directional shift register 160.

In order to synchronize the driving period of the data lines 114 with the stable output period of the image signals VID1 to VID6, the transfer signals SRI to SRn are logically multiplied by the enable signals ENB in the enable circuits 170a, 170b, and so on and are output as the sampling signals S1 to Sn. Accordingly, the image signals are in synchronization with the sampling signals (for example, the image signals VID1 to VID6 are in synchronization with the sampling signal S1). Thus, accurate display can be achieved.

Although the enable signal ENB1 or ENB2 is supplied depending on whether the stage of the bi-directional shift register 160 is an even number stage or an odd number stage in the first exemplary embodiment, sampling may be performed by only one enable signal ENB. Alternatively, each of the transfer signals SRI to SRn output from the corresponding stages SRS(i), where i represents 1, 2, 3, . . . , n, of the bi-directional shift register 160 may be divided into a plurality of signals to be output in parallel, and a plurality of sampling signals obtained by logically multiplying with the plurality of enable signals, the number of enable signals being equal to the number of divided transfer signals, may be output. Each of the stages SRS(i) of the bi-directional shift register 160 controls a plurality of sampling circuits, so that the number of stages of the bi-directional shift register 160 can be reduced.

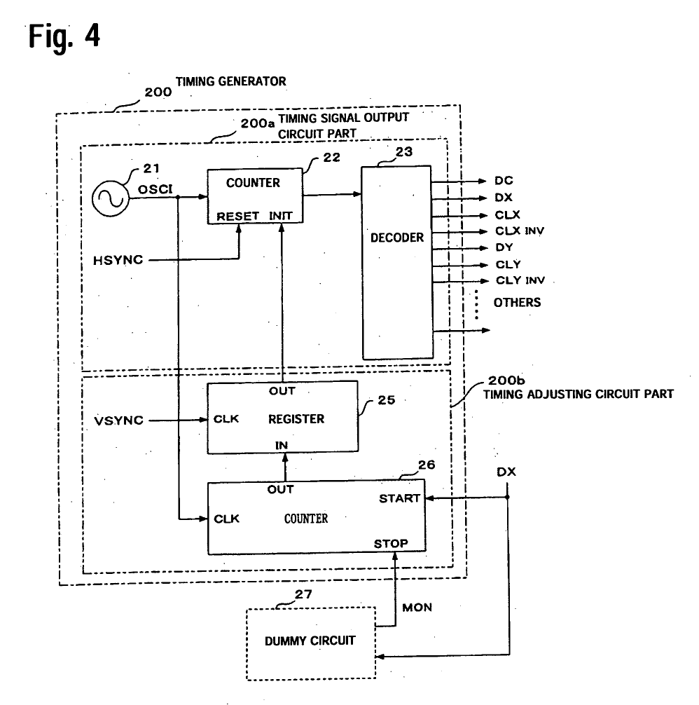

The structure and operation of the timing generator 200 according to the first exemplary embodiment will now be described in detail with reference to FIG. 4, in addition to FIG. 1. FIG. 4 is a circuit schematic showing the structure of the timing generator 200 according to the first exemplary embodiment.

As shown in FIG. 4, the timing generator 200 includes a timing signal output circuit part 200a and a timing adjusting circuit part 200b.

The timing signal output circuit part 200a includes an oscillator circuit 21, a counter 22, and a decoder 23. The oscillator circuit 21 outputs a clock signal OSCI having a frequency several times as large as a dot clock DC. The counter 22 is reset in synchronization with the rising edge of a horizontal synchronization signal HSYNC. After reset, the counter 22 counts the number of pulses of the clock signal OSCI. Here, the counter 22 has an initial value input terminal INIT to input an initial value of the count rate when the counter 22 is reset. The decoder 23 decodes the output value of the counter 22 and outputs various timing signals, such as the dot clock DC, the transfer start pulses DX and DY, the clock signals CLX and CLY, and the inversion clock signals CLX_{INV} and CLY_{INV}.

The timing adjusting circuit part 200b includes a register 25 and a counter 26. When a signal at an input terminal START rises to an H′ level, the counter 26 starts counting the clock signal OSCI. When a signal at an input terminal STOP rises to an H′ level, the counter 26 terminates counting. The register 25 is a storing device and latches the count result of the counter 26 in synchronization with a vertical synchronization signal VSYNC.

In particular, output pulses from the dummy circuit 27, to be described in detail later, are input to the counter 26. The count result of the output pulses indicates a delay time of sampling signals in the buffer circuit and the sampling circuit. Since the initial value in the counter 22 is preset on the basis of the count result, timing signals, such as the dot clock DC, the transfer start pulse DX, and the clock signal CLX, are output earlier by a time corresponding to the count result. With the operation described above, the timing adjusting circuit part 200b is capable of measuring a delay time by counting output pulses from the dummy circuit 27 and of performing timing adjustment of clock signals on the basis of the measured delay time.

As described above, in the first exemplary embodiment, the dummy circuit 27 creates a detection signal MON, which is an example of a delay signal indicating the amount of delay of a sampling pulse according to an aspect of the present invention. The detection signal MON is fed back to the bi-directional shift register 160 via the timing generator 200 so that the amount of delay of the sampling signals S1 to Sn, which are an example of the sampling pulses according to an aspect of the present invention, is reduced.

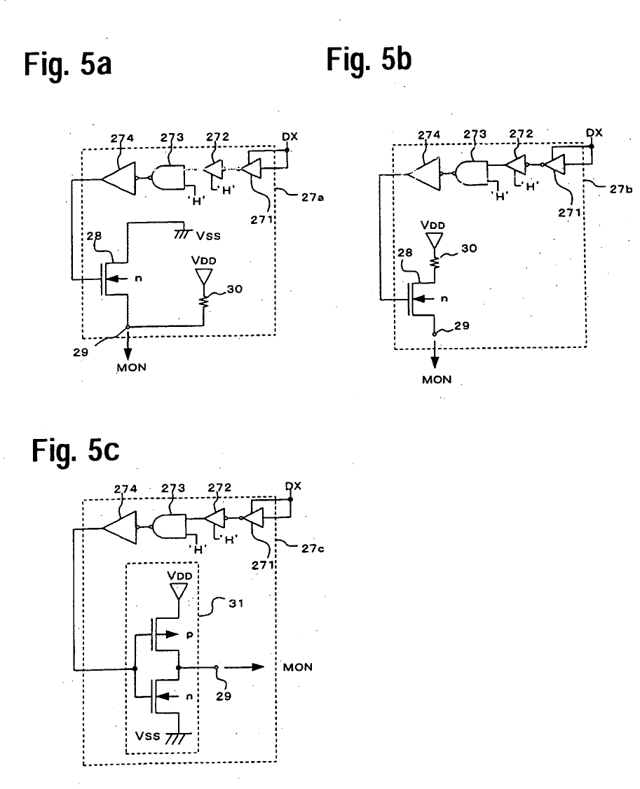

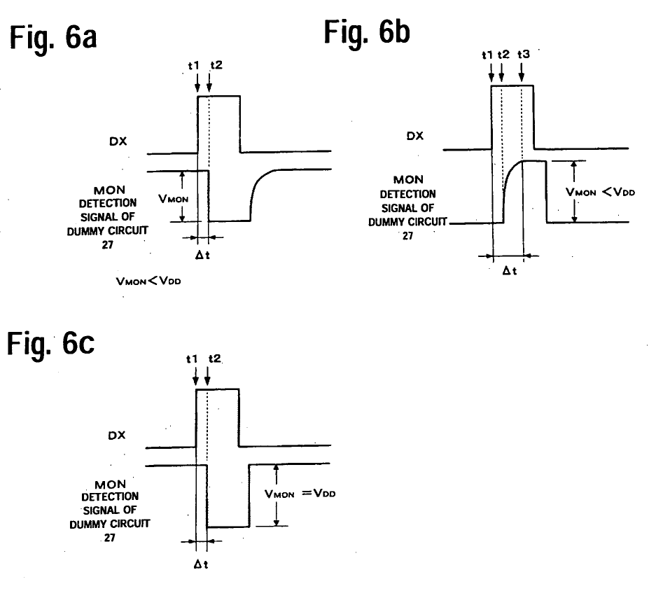

The structure and operation of the dummy circuit 27 according to the first exemplary embodiment will now be described in detail with reference to FIGS. 5 and 6, in addition to FIGS. 1 and 2. In the circuit schematic of FIG. 2, the detailed structure of the dummy circuit 27 according to the first exemplary embodiment and the connection relationship of the dummy circuit 27 and the data line driving circuit 150, in addition to the sampling circuit 140 and the data line driving circuit 150, are shown. FIGS. 5a-5c include: FIG. 5a showing the structure of a dummy circuit 27a according to a working example, which is the structure of the dummy circuit 27 according to the first exemplary embodiment shown in FIG. 2; FIG. 5b showing the structure of a dummy circuit 27b according to comparative example 1; and FIG. 5c showing the structure of a dummy circuit 27c according to comparative example 2. FIG. 6 includes timing charts showing the detection state of signal delay in the dummy circuit 27a according to the working example, in the dummy circuit 27b according to comparative example 1, and in the dummy circuit 27c according to comparative example 2.

As shown in FIG. 2, since the dummy circuit 27 according to the first exemplary embodiment simulates the structure of the data line driving circuit 150 and the sampling circuit 140, the dummy circuit 27 includes a clocked inverter 271 and a clocked inverter 272. The clocked inverter 271 corresponds to a corresponding clocked inverter 161a, 161b, or the like constituting the bi-directional shift register 160 and the clocked inverter 272 corresponds to a corresponding clocked inverter 162a, 162b, or the like constituting the bi-directional shift register 160. Also, the dummy circuit 27 further includes a NAND circuit 273 and an inverter 274. The NAND circuit 273 corresponds to a corresponding NAND circuit 171a, 171b, or the like constituting the buffer circuit (or the enable circuit) and the inverter 274 corresponds to a corresponding inverter 172a, 172b, or the like constituting the buffer circuit (or the enable circuit). Furthermore, the dummy circuit 27 includes a first-conductivity-type TFT 28 corresponding to the sampling switch 141 constituting the sampling circuit 140. The transfer start pulse DX (hereinafter, “input signal DX” in the explanation for the dummy circuit 27), which is input to the data line driving circuit 150, is also input to the clocked inverter 271 in the dummy circuit 27. Also, the source of the first-conductivity-type TFT 28 is connected to a low-potential power supply V_{SS} in the driving circuit 120 and the drain of the first-conductivity-type TFT 28 is biased at a high-potential power supply VDD in the driving circuit 120 and is connected to a detection terminal 29. The detection terminal 29 is connected to the counter 26 in the timing generator 200 and the detection signal MON delayed in the dummy circuit 27a is output to the counter 26. Also, the detection terminal 29 is connected to the internal power supply V_{DD} of the liquid crystal panel 100 via a load resistor 30 and is biased at a high potential.

As described above with reference to FIG. 2, six sampling switches 141 in the sampling circuit 140 are connected in parallel for each stage SRS(i), where i represents 1, 2, 3, . . . , n, of the bi-directional shift register 160. In the dummy circuit 27, which simulates the sampling circuit 140, six first-conductivity-type TFTs 28 are connected in parallel in a similar manner. For the sake of simple explanation, however, the dummy circuit 27 is illustrated such that one first-conductivity-type TFT 28 is connected, and the other five first-conductivity-type TFTs 28 are not shown in FIGS. 2 and 5. This also applies to comparative examples 1 and 2 in FIG. 5.

With the structure described above, the dummy circuit 27 simulates a path corresponding to one stage of the bi-directional shift register 160, from the bi-directional shift register 160 to the sampling circuit 140. Thus, the sampling operation of an image signal is performed in the sampling circuit 140 by a sampling pulse generated in the data line driving circuit 150, and at the same time, a delay signal indicating the amount of delay of the sampling pulse is generated in the dummy circuit 27 to be detected as a detection signal MON in the detection terminal 29. Then, the timing adjusting circuit part 200b of the timing generator 200 measures the delay time, as described above, on the basis of the detection signal MON. Thus, the detection signal MON, which is a delay signal, in the dummy circuit 27 is fed back to the bi-directional shift register 160 so that the amount of delay of the sampling pulse is reduced.

The accuracy of delay time measurement is determined in accordance with how well the characteristics of the dummy circuit 27, which is a detection circuit of a delay signal, simulates the characteristics of the sampling circuit 140 and the data line driving circuit 150. Accordingly, with the structure described above, the dummy circuit 27 can detect a delay time of a sampling pulse with a relatively high accuracy, thus reducing the adverse influence of the delay of the sampling pulse upon a display image.

The dummy circuit 27 may be formed on the device substrate of the liquid crystal panel 100 in the same process as elements of the data line driving circuit 150 and the sampling circuit 140, which are to be simulated. The size of elements in the dummy circuit 27 may be equal to the size of the corresponding elements in the sampling circuit 140 and the data line driving circuit 150. Also, the channel width of the first-conductivity-type TFTs 28 may be equal to the channel width of the corresponding sampling switches 141.

With the structure described above, the degree of how well the dummy circuit 27 simulates the data line driving circuit 150 and the sampling circuit 140 is further increased, thus achieving a very high accuracy in detecting the amount of delay of a sampling pulse.

Furthermore, each of the first-conductivity-type TFTs 28 may include an N-channel TFT.

With the structure described above, an electron moves as a carrier between the drain and source. Thus, for example, compared with a case where each of the first-conductivity-type TFTs 28 includes a P-channel TFT (in this case, a carrier is a positive hole), higher carrier mobility and a higher switching reaction rate to an input signal “ON” (an input signal “OFF” for a P-channel) for the gate can be achieved. Thus, a delay signal can be detected with a relatively high accuracy.

If each of the sampling switches 141 in the sampling circuit 140 includes a P-channel TFT, the dummy circuit 27 may also include P-channel TFTs. Even if the P-channel TFTs are used, the sampling switches 141 can be accurately simulated. Thus, the amount of delay of a sampling pulse is detected with high accuracy. Consequently, a similar advantage can be achieved in terms of reduction in the adverse influence of a delay.

The operation of the dummy circuit 27 according to the first exemplary embodiment will now be described with reference to FIGS. 5 and 6. In particular, advantages of the dummy circuit 27 according to the first exemplary embodiment will be explained by comparing it with the dummy circuit 27b according to comparative example 1 and the dummy circuit 27c according to comparative example 2.

As shown in FIG. 5b, the first-conductivity-type TFT 28 of the dummy circuit 27b according to comparative example 1 is connected in a different manner than the first-conductivity-type TFT 28 of the dummy circuit 27a according to the working example shown in FIG. 5a. An input signal DX is delayed by the elements from the clocked inverter 271 to the inverter 274 and is input to the gate in a similar manner. The source is connected to the internal power supply V_{DD} of the liquid crystal panel 100 via the load resistor 30 to be biased at a high potential. The drain is connected to the detection terminal 29, and the output signal can be extracted as a detection signal MON indicating a delay time from the detection terminal 29.

As shown in FIG. 5c, instead of the first-conductivity-type TFT 28 of the dummy circuit 27a according to the working example shown in FIG. 5a, a complementary TFT, such as an inverter 31 made of a complementary MOS (CMOS) TFT, is connected in the dummy circuit 27c according to comparative example 2, and the output signal can be extracted as a detection signal MON indicating a delay time from the detection terminal 29.

In the dummy circuit 27a according to the working example, an input signal DX is inverted four times via the clocked inverter 271, the clocked inerter 272, the NAND circuit 273, and the inverter 274 while being delayed and is supplied to the gate of the first-conductivity-type TFT 28. The drain of the first-conductivity-type TFT 28 is biased at a voltage obtained by reducing the potential of the internal power supply V_{DD} by the load resistor 30. When the input signal to the gate rises to an “H” level, the first-conductivity-type TFT 28 including an N-channel TFT becomes an “ON” state, and current flows to the low-potential power supply V_{SS} connected to the source of the first-conductivity-type TFT 28. Thus, a signal at the detection terminal 29 connected to the drain becomes an “L” level and the signal is detected as a falling signal due to the “ON” state of the first-conductivity-type TFT 28.

For the operation described above, as shown in FIG. 6a, a time difference of Δt minutes is generated between time t1 at which the input signal DX rises to the “H” level and time t2 at which the detection signal MON falls due to signal delay when the signal passes through the elements 271 to 274 and the operation of the first-conductivity-type TFT. The input signal DX and the falling edge detection signal MON are compared with each other and counted by the counter 26 of the timing generator 200 to measure the time difference Δt as a delay time of the sampling pulse.

As described above, in particular, the dummy circuit 27a according to the working example detects the falling edge from a state in which the voltage of the detection terminal 29 is already biased. Thus, as in the sampling switches 141, the operation time of the switching itself of the delay time Δt can be reduced to a negligible amount. Consequently, the amount of delay of the sampling pulse can be detected with very high accuracy, and adjustment corresponding to such a high accuracy can also be achieved.

Furthermore, in the first exemplary embodiment, in particular, the voltage of the high-potential power supply V_{DD} is reduced via the load resistor 30 and the drain of the first-conductivity-type TFT 28 is biased at a relatively low potential. Here, in a method to detect a falling signal as in the dummy circuit 27a according to the working example, since the switching operation starts when the level of a signal input to the gate of the first-conductivity-type TFT 28 is equal to or higher than a threshold voltage, detection of a delay signal is not affected by the potential at which the drain is biased. Thus, by setting the load resistor 30 to any value, the power supply voltage V_{DD} is reduced in advance so that the drain of the first-conductivity-type TFT 28 is biased at a relatively low potential.

With the structure described above, the first-conductivity-type TFT 28 does not need high breakdown voltage characteristics.

Here, as shown in FIG. 5b, in comparative example 1, in accordance with the rising edge of a signal input to the gate of the first-conductivity-type TFT 28, the internal power supply V_{DD} at which the source is biased and the switching “ON” operation of the first-conductivity-type TFT 28 cause current to flow to the detection terminal 29 connected to the drain. Here, as shown in FIG. 6b, a rising signal MON is detected, unlike the case using the dummy circuit 27a according to the working example. Thus, signal rounding that is not negligible occurs due to the transient characteristics at the rising edge. Specifically, a delay time (t2 to t3) due to the switching operation itself exists, and the accuracy of detecting the delay time Δt is thus reduced. For this reason, with the circuit structure of the dummy circuit 27a according to the working example, the falling edge from the state already biased at a high potential can be detected as described above. Thus, a fast reaction to the switching operation and a high accuracy of detecting a delay time can be achieved, as compared with the structure according to comparative example 1.

As shown in FIG. 5c, in comparative example 2, depending on whether the input signal DX is in the “ON” state or the “OFF” state, the “falling edge” and the “rising edge” of a signal can be detected by the detection terminal 29. In this case, however, the inverter 31 has a structure different from the sampling switch 141. The inverter 31 is different from the sampling switch 141 in that the inverter 31 includes a complementary TFT composed of at least an N-channel TFT and at least a P-channel TFT. Also, the size (in particular, the channel width) of the inverter 31 is different from that of the sampling switch 141. Thus, an error that is not a negligible amount occurs between the delay time of a sampling pulse via the sampling switch 141 including a first-conductivity-type TFT and the delay time measured using the dummy circuit 27c according to comparative example 2. However, in the dummy circuit 27a according to the working example, the first-conductivity-type TFT 28 has the same structure as the sampling switch 141, and it is obvious that, as compared with comparative example 2, the working example is advantageous in measuring a delay time with high accuracy.

Furthermore, with the structure according to comparative example 2, the bias of the internal power supply V_{DD} of a relatively high potential is directly applied as described above. This causes disadvantages in terms of the breakdown voltage characteristics required for each TFT element, as compared with the dummy circuit 27a according to the working example. In order to avoid such a direct application of the bias of the internal power supply voltage V_{DD}, even if, for example, the load resistor 30 is used and bias is applied after reducing the voltage, as in the dummy circuit 27a according to the working example or the dummy circuit 27b according to comparative example 1, signal rounding that is not negligible occurs when the detection signal MON rises, as in the dummy circuit 27b according to comparative example 1. Thus, it is obvious that this structure causes disadvantages in terms of accuracy in measuring signal delay, as compared with the dummy circuit 27a according to the working example.

Comparative examples 1 and 2 shown in FIGS. 5b and 5c, respectively, are comparative examples to explain outstanding advantages of the working example of the first exemplary embodiment shown in FIG. 5a and are not excluded from the electro-optical device according to an aspect of the present invention. In a broad sense, comparative examples 1 and 2 shown in FIGS. 5b and 5c are included in the technical scope of the present invention. Although comparative examples 1 and 2 have drawbacks as compared with the working example shown in FIG. 5a, corresponding advantages can be achieved as compared with the related art examples described above.

Second Exemplary Embodiment

An electro-optical device according to a second exemplary embodiment of the present invention will now be described.

The electro-optical device according to the second exemplary embodiment is different from the electro-optical device according to the first exemplary embodiment in the size or the planar pattern of component parts of the dummy circuit 27. The circuit structure and operation of the dummy circuit 27, the entire structure of the liquid crystal device, and the structure and operation of the circuits in the liquid crystal panel 100 according to the second exemplary embodiment are similar to those according to the first exemplary embodiment. Thus, only parts that are different from the first exemplary embodiment will be explained below. Since all component parts according to the first exemplary embodiment correspond to those according to the second exemplary embodiment, they are not illustrated here.

As described above, since the sampling circuit 140 includes the plurality of sampling switches 141 connected in parallel, the dummy circuit 27 also includes the plurality of first-conductivity-type TFTs 28, which simulate the sampling switches 141, connected in parallel and the number of first-conductivity-type TFTs 28 is equal to the number of sampling switches 141. With this structure, the same delay time can be detected. This structure, however, requires a relatively large space on the limited device substrate of the liquid crystal panel 100 in terms of layout design.

In order to detect signal delay with high accuracy, the dummy circuit 27 according to the second exemplary embodiment is arranged in a space as small as possible on the assumption that the dummy circuit 27 is provided on the same device substrate, as in the first exemplary embodiment. A method to arrange the dummy circuit 27 as described above will now be described.

In the second exemplary embodiment, the channel width of the first-conductivity-type TFT 28 in the dummy circuit 27 is smaller than the channel width of the sampling switch 141 of the sampling circuit 140.

With this structure, forming a compact dummy circuit on a limited space on the substrate avoids the problem of space shortage. Alternatively, miniaturization of the substrate and the entire electro-optical panel, including an area required to form a dummy circuit, may be achieved.

In the second exemplary embodiment, in particular, the ratio of the size of the sampling switch 141 of the sampling circuit 140 to the size of the buffer circuit (that is, the enable circuit 170a, 170b, or the like) in the preceding stage is equal to the ratio of the size of the first-conductivity-type TFT 28 of the corresponding dummy circuit 27 to the size of the buffer circuit (that is, the NAND circuit 273 and the inverter 274) located in the preceding stage.

With this structure, even if the dummy circuit 27 is miniaturized as compared with the simulated circuit, the degree of simulation is kept high. Thus, signal delay can be measured with high accuracy.

The ratio of the size of the first-conductivity-type TFT 28 of the dummy circuit 27 to the size of all other component parts (elements 271 to 274) may be equal to the ratio of the size of the sampling switch 141, which is to be simulated, to the size of component parts (for example, inverters 161a, 162a, 171a, 172a) for one stage of a shift register up to the sampling circuit 140. In the case where the first-conductivity-type TFT 28 of the dummy circuit 27 is smaller than the sampling switch 141, the size of all other component parts may be reduced by the same ratio.

With the structure described above, even in a case where the channel width of the first-conductivity-type TFT 28 is smaller than that of the sampling switch 141, which is to be simulated, the ratio of the capacitance of the first-conductivity-type TFT 28 to the capacitance of all component parts in the preceding stage is equal to the ratio of the capacitance of the sampling switch 141 in the circuit to be simulated to the capacitance of all component parts in the preceding stage. Thus, compared with the case where the channel width of the first-conductivity-type TFT 28 is equal to the channel width of the sampling switch 141, as in the first exemplary embodiment, substantially the same delay time can be detected and the layout dimensions of the dummy circuit 27 can be reduced.

Third Exemplary Embodiment

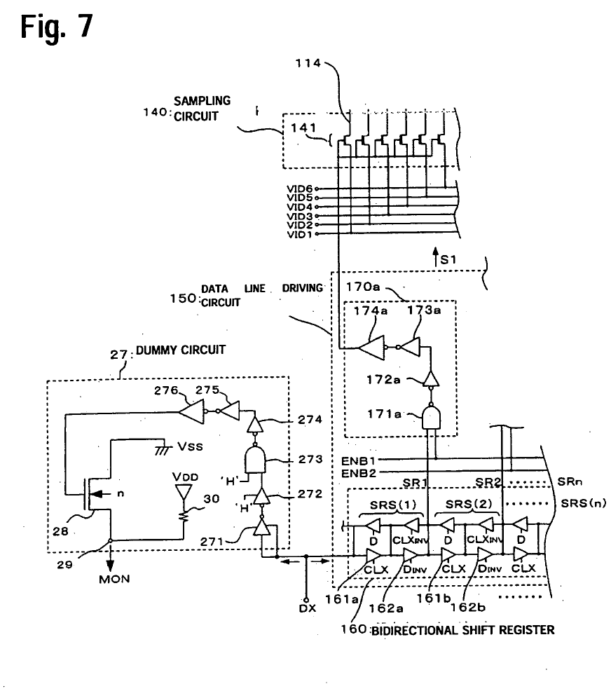

An electro-optical device according to a third exemplary embodiment of the present invention will now be described with reference to FIG. 7.

The electro-optical device according to the third exemplary embodiment is different from the electro-optical device according to the first exemplary embodiment in the structure of the dummy circuit 27 and the enable circuits 170a, 170b, and the like constituting an example of the buffer circuit in the data line driving circuit 150. The operation of the dummy circuit 27 and the entire structure and operation of the liquid crystal device according to the third exemplary embodiment are similar to those according to the first exemplary embodiment. Thus, only parts that are different from the first exemplary embodiment will be explained below.

In the third exemplary embodiment, as shown in FIG. 7, each of the enable circuits 170a, 170b, and so on, which is an example of the buffer circuit, includes inverters provided in a plurality of stages. Specifically, inverters 173a and 174a are added to the structure according to the first exemplary embodiment.

With the structure described above, a relatively large signal delay due to a wiring capacitance of the entire path from the bi-directional shift register 160 to the sampling circuit 140 can be suppressed.

The dummy circuit 27 that simulates the enable circuit described above to detect signal delay also includes inverters provided in a plurality of stages, the number of stages in the dummy circuit 27 being equal to the number of stages in the enable circuit, as shown in FIG. 7. Specifically, inverters 275 and 276 are added as compared with the dummy circuit 27 according to the first exemplary embodiment.

With the structure described above, in the case where the inverters functioning as buffers provided in the plurality of stages are connected to each other in the data line driving circuit 150 as described above, simulation is performed by using the same number of stages. Thus, signal delay can be detected with high accuracy.

In the third exemplary embodiment, in particular, the dummy circuit 27 is formed on the device substrate of the liquid crystal panel 100 in the same process as elements of the sampling circuit 140 and the data line driving circuit 150. Also, the size of elements of the dummy circuit 27 is equal to the size of the corresponding elements of the sampling circuit 140 and the data line driving circuit 150 to be simulated. Also, in the third exemplary embodiment, in particular, the channel width of the first-conductivity-type TFTs 28 is equal to the channel width of the corresponding sampling switches 141.

With the structure described above, the degree of simulation of the data line driving circuit 150 and the sampling circuit 140 by the dummy circuit 27 is further increased. Thus, the amount of delay of a sampling pulse can be detected with very high accuracy.

The other structure and operation of the dummy circuit 27 are the same as those according to the first exemplary embodiment. Thus, the amount of delay of the sampling pulse can be detected with high accuracy similar to the first exemplary embodiment.

Fourth Exemplary Embodiment

An electro-optical device according to a fourth exemplary embodiment of the present invention will now be described.

The electro-optical device according to the fourth exemplary embodiment is different from the electro-optical device according to the third exemplary embodiment in the size or the planar pattern of the component parts of the dummy circuit 27. The circuit structure and operation of the dummy circuit 27, the entire structure of the liquid crystal device, and the structure and operation of the circuits in the liquid crystal panel 100 are similar to those according to the third exemplary embodiment. Thus, only parts that are different from the third exemplary embodiment will be explained. Since all component parts according to the third exemplary embodiment correspond to those according to the fourth exemplary embodiment, they are not illustrated here.

In the fourth exemplary embodiment, the channel width of the first-conductivity-type TFT 28 of the dummy circuit 27 is smaller than the channel width of the sampling switch 141 of the sampling circuit 140.

With the structure described above, forming a compact dummy circuit on a limited space on the substrate avoids the problem of space shortage. Alternatively, miniaturization of the substrate and the entire electro-optical panel, including an area required to form a dummy circuit, may be achieved.

In the fourth exemplary embodiment, in particular, the ratio of the size of the first-conductivity-type TFT 28 of the dummy circuit 27 to the size of the inverter 276 in the final stage of the buffer circuit in the preceding stage is equal to the ratio of the size of the sampling switch 141 of the sampling circuit 140 to the size of the inverter 174a in the final stage of the buffer circuit in the preceding stage.

With the structure described above, even if the dummy circuit 27 is miniaturized as compared with the simulated circuit, since an inverter in the final stage, in which the delay constraints of a sampling pulse is relatively high, among buffers in a plurality of stages constituting the buffer circuit is simulated, the degree of simulation is kept high and signal delay can be measured with high accuracy.

Also, the ratio of the size of the first-conductivity-type TFT 28 of the dummy circuit 27 to the size of all other component parts (elements 271 to 276) may be equal to the ratio of the size of the sampling switch 141, which is to be simulated, to the size of component parts (for example, inverters 161a, 162a, 171a, 172a, 173a, and 174a) of one stage of the shift register up to the sampling circuit 140. Specifically, in the case where the size of the first-conductivity-type TFT 28 of the dummy circuit 27 is smaller than the size of the sampling switch 141, all other component parts may be reduced by the same ratio.

With the structure described above, even in a case where the channel width of the first-conductivity-type TFT 28 is smaller than that of the sampling switch 141, which is to be simulated, the ratio of the capacitance of the first-conductivity-type TFT 28 to the capacitance of all component parts in the preceding stage is equal to the ratio of the capacitance of the sampling switch 141 of the circuit to be simulated to the capacitance of all component parts in the preceding stage. Thus, compared with the case where the channel width of the first-conductivity-type TFT 28 is equal to the channel width of the sampling switch 141, as in the first exemplary embodiment, substantially the same delay time can be detected and the layout dimensions of the dummy circuit 27 can be reduced.

The bi-directional shift register 160 according to the first to fourth exemplary embodiments may be formed on the substrate constituting the liquid crystal panel 100 as an IC attached externally or attached later.

With the structure described above, the bi-directional shift register 160 can be mounted relatively easily. In contrast, since the dummy circuit is formed on the same substrate as the buffer circuit and the sampling circuit, which are simulated by the dummy circuit, the degree of simulation by the dummy circuit 27 can be increased.

As described above, the dummy circuit 27 according to the first to fourth exemplary embodiments is formed in the same process as elements of the data line driving circuit 150 and the sampling circuit 140 in the liquid crystal panel 100, and the dummy circuit 27 functions as a simulation circuit having the same circuit structure. A falling edge of a signal is detected with a quick switching operation. Thus, a delay signal that is equal to the actual signal delay of a sampling pulse can detected, the delay time can be measured with high accuracy, and the detection signal can be fed back to the driving circuit.

Modifications

The dummy circuit according to the first to fourth exemplary embodiments simulates the clocked inverters and the enable circuit in the data line driving circuit and the sampling circuit relatively accurately. However, as modifications of the first to fourth exemplary embodiments, a dummy circuit may simulate at least part of the data line driving circuit, the buffer circuit (enable circuit), and the sampling circuit. Even in this case, the delay time can be measured with an accuracy corresponding to the degree of simulation, and the adverse influence of the delay can be correspondingly reduced by feeding back a delay signal. In particular, simulating one or more circuit parts that mainly cause delay or that constrain the delay among the data line driving circuit, the enable circuit, and the sampling circuit effectively reduces or prevents the adverse influence of the delay. For example, simulating an inverter in the final stage in the buffer circuit from among the inverters in the plurality of stages connected in series effectively reduces the adverse influence of the delay. At the same time, a partial simulation by the dummy circuit reduces the area in the limited space on the device substrate on which the dummy circuit is formed. Thus, this structure is advantageous in reducing the size of the device substrate and the entire device.

Overall Structure of Liquid Crystal Device

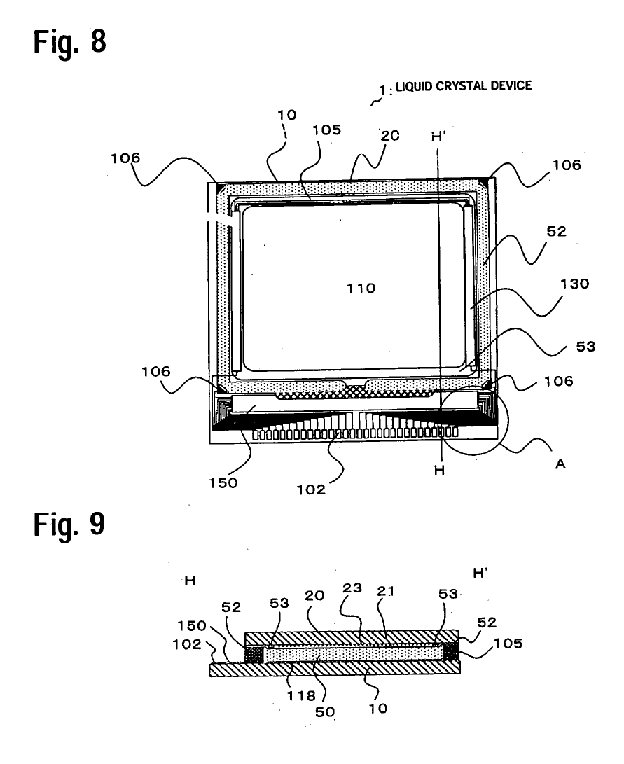

The overall structure of the liquid crystal device according to the first to fourth exemplary embodiments of the present invention with the structure described above will now be described with reference to FIGS. 8 and 9. FIG. 8 is a schematic of the liquid crystal device substrate 10, which is a TFT array substrate, and each component part provided on the liquid crystal device substrate 10 when viewed from the side of an opposing substrate 20. FIG. 9 is a cross-sectional view taken along the plane H-H′ of FIG. 8.

As shown in FIGS. 8 and 9, a seal member 52 is provided around the image display area 110 (that is, an area of the liquid crystal device in which an image is displayed in accordance with a change in the orientation state of a liquid crystal layer 50) defined by the plurality of pixel electrodes 118 on the liquid crystal device substrate 10. The seal member 52 is made of a photocurable resin and bonds the substrates around the image display area 110 to surround the liquid crystal layer 50. A frame-shaped light-shielding film 53 is provided on the opposing substrate 20 between the image display area 110 and the seal member 52. The frame-shaped light-shielding film 53 and a light-shielding layer 23 may be provided on the liquid crystal device substrate 10.

The scanning line driving circuits 130 are provided in parts along the left and right sides of the image display area 110. If driving delay of the scanning lines 112 does not cause a big problem, the scanning line driving circuit 130 may be provided only on one side of the scanning lines 112.

The data line driving circuit 150 and an external circuit connection terminal 102 to input a signal from the outside are provided along the lower side of the image display area 110 in an area outside the seal member 52. The scanning line driving circuits 130 are provided along the left and right sides of the image display area 110. The data line driving circuits 150 may be provided along the upper and lower sides of the image display area 110. In this case, for example, data lines in odd-numbered columns may be electrically connected to one of the data line driving circuits 150 and data lines in even-numbered columns may be electrically connected to the other one of the data line driving circuits 150, so that data lines are driven from the upper and lower sides like combs. Furthermore, a plurality of wiring lines 105 to supply a power supply and a driving signal to the scanning line driving circuits 130 are provided in the upper side of the image display area 110. Also, an upper and lower conductive material 106 to electrically connect the liquid crystal device substrate 10 and the opposing substrate 20 is provided at at least one corner of the opposing substrate 20. The opposing substrate 20 having an outline substantially equal to the seal member 52 is fixed to the liquid crystal device substrate 10 using the seal member 52.

Also, although an external control circuit to output a clock signal, an image signal, and the like to the data line driving circuit 150 and the scanning line driving circuit 130 is provided outside the liquid crystal device in the exemplary embodiments described above, the present invention is not limited to this. The control circuit may be provided in the liquid crystal device.

Only a clock signal may be supplied from the external control circuit and a circuit to generate a counter-phase clock signal may be provided on the liquid crystal device substrate.

The liquid crystal device described above may be a color liquid crystal projector or the like. In this case, three liquid crystal devices are used as light valves for R, G, and B, respectively. Light of each color separated by a dichroic mirror for RGB color separation enters each panel as incident light. Thus, in the exemplary embodiments described above, a color filter is not provided on the opposing substrate 20. However, in the liquid crystal device, RGB color filters may be provided, together with a protective film for the color filters, in predetermined areas of the opposing substrate 20 that are not provided with the light-shielding layer 23 and that face the pixel electrodes 118. Accordingly, the liquid crystal device according to an aspect of the present invention may also be a color liquid crystal device, such as a color liquid crystal television of a direct viewing type or a reflection type, other than a liquid crystal projector.

Also, the switching element used for the liquid crystal device may be a positive staggered or coplanar polysilicon TFT. Alternatively, the switching element used in an aspect of the present invention is applicable to a TFT of other types, such as an inverted-staggered TFT and an amorphous silicon TFT.

The liquid crystal layer 50 is made of nematic liquid crystal, as an example, in the liquid crystal device. However, use of macromolecule distributed liquid crystal in which liquid crystal is distributed as microparticles in a macromolecule eliminates the necessity of an alignment film, the polarization film, a polarization plate, and the like. Thus, an increase in the brightness of the liquid crystal device and a reduction in the power consumption due to an increased light utilization efficiency can be achieved.

Instead of arranging the data line driving circuit 150 and the scanning line driving circuit 130 on the liquid crystal device substrate 10, for example, the data line driving circuit 150 and the scanning line driving circuit 130 may be electrically and mechanically connected to a driving LSI mounted on a tape automated bonding (TAB) substrate via an anisotropic conductive film provided near the liquid crystal device substrate 10.

Although the structure of the scanning line driving circuit 130 is not described in the exemplary embodiments described above, in particular, a shift register part can be arranged in a similar manner to the data line driving circuit 150.

Also, the electro-optical device may be an electrophoretic device, an electroluminescent (EL) device, a device using an electron emission element (a field emission display and a surface conduction electron-emitter display), or the like.

Electronic Apparatus

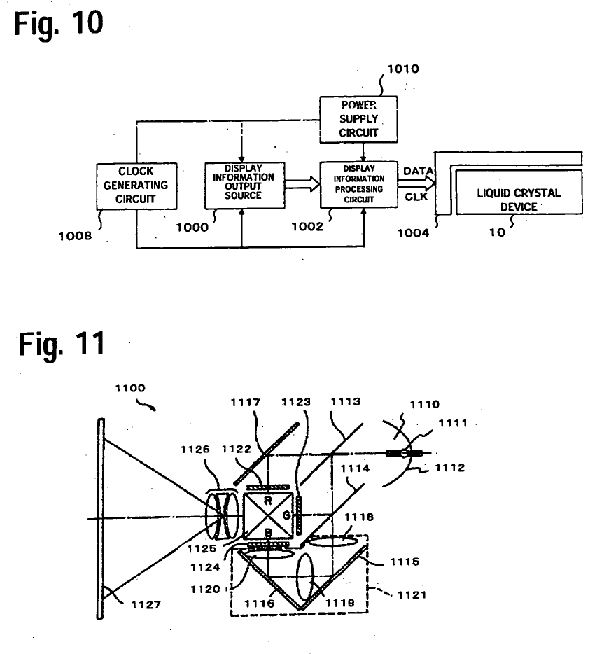

An electronic apparatus according to an aspect of the present invention provided with the liquid crystal device 1 described above will be described with reference to FIGS. 10 to 13.

FIG. 10 is a schematic showing the structure of the electronic apparatus provided with the liquid crystal device 1.

Referring to FIG. 10, the electronic apparatus includes a display information output source 1000, the external display information processing circuit 1002 described above, a display driving circuit 1004 including the scanning line driving circuit 130 and the data line driving circuit 150, the liquid crystal device 1, a clock generating circuit 1008, and a power supply circuit 1010. The display information output source 1000 includes memories, such as a read only memory (ROM), a random access memory (RAM), and an optical disk device, and a tuning circuit to output a tuned television signal. The display information output source 1000 outputs display information, such as an image signal in a predetermined format, to the display information processing circuit 1002 on the basis of a clock signal from the clock generating circuit 1008. The display information processing circuit 1002 includes various known processing circuits, such as an amplifying and polarity-reversing circuit, a phase expansion circuit, a rotation circuit, a gamma correction circuit, and a clamping circuit. The display information processing circuit 1002 sequentially generates a digital signal from the display information input on the basis of the clock signal from the clock generating circuit 1008 and outputs the digital signal, together with the clock signal CLK, to the display driving circuit 1004. The display driving circuit 1004 drives the liquid crystal device 1 using the driving method described above by the scanning line driving circuit 130 and the data line driving circuit 150. The power supply circuit 1010 supplies predetermined power to each of the circuits described above. The display driving circuit 1004 may be mounted on the liquid crystal device substrate constituting the liquid crystal device 1, and the display information processing circuit 1002 may also be mounted on the liquid crystal device substrate.

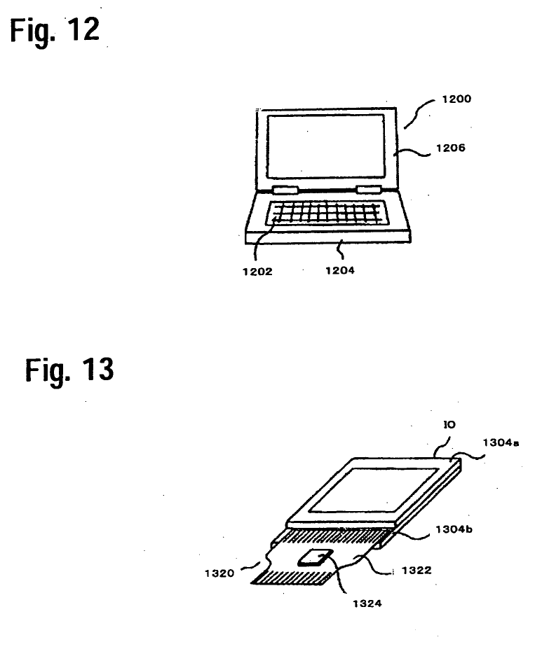

The electronic apparatus having such a structure may be a liquid crystal projector shown in FIG. 11, a multimedia-compatible personal computer (PC) and an engineering workstation (EWS) shown in FIG. 12, a mobile telephone, a word processor, a television set, a viewfinder type or monitor direct-view type video tape recorder, an electronic notebook, an electronic desk calculator, a car navigation system, a POS terminal, a device provided with a touch panel, or the like.

Specific examples of the electronic apparatus arranged as described above are shown in FIGS. 11 to 13.

Referring to FIG. 11, a liquid crystal projector 1100, which is an example of the electronic apparatus, is of a projection type and includes a light source 1110, dichroic mirrors 1113 and 1114, reflecting mirrors 1115, 1116, and 1117, an incident lens 1118, a relay lens 1119, an exit lens 1120, liquid crystal light valves 1122, 1123, and 1124, a cross-dichroic prism 1125, and a projector lens 1126. The liquid crystal light valves 1122, 1123, and 1124 are three liquid crystal display modules each including the liquid crystal device 1 including the display driving circuit 1004 mounted on the liquid crystal device substrate and are used as liquid crystal light valves. Also, the light source 1110 includes a lamp 1111, such as a metal halide lamp, and a reflector 1112 reflecting the light from the lamp 1111.

In the liquid crystal projector 1100 arranged as described above, the blue and green light reflecting dichroic mirror 1113 transmits red light from among the white light from the light source 1110 and reflects blue and green light. The transmitted red light is reflected by the reflecting mirror 1117 and is input to the liquid crystal light valve 1122 for red light. Green light from among color light reflected by the dichroic mirror 1113 is reflected by the green light reflecting dichroic mirror 1114 and is input to the liquid crystal light valve 1123 for green light. Also, the second dichroic mirror 1114 transmits blue light. In order to reduce or prevent optical loss due to a long optical path, light guiding device 1121 including a relay lens system including the incident lens 1118, the relay lens 1119, and the exit lens 1120 is provided for blue light. Accordingly, the blue light is input to the liquid crystal light valve 1124 for blue light via the light guiding device 1121. Light of three colors modulated by the corresponding light valves is input to the cross-dichroic prism 1125. The prism includes four right-angle prisms attached together and a dielectric multilayer film reflecting red light and a dielectric multilayer film reflecting blue light are arranged so as to cross each other on the internal surfaces. The light of three colors is combined by the dielectric multilayer films to form light indicating a color image. The combined light is projected on a screen 1127 by the projector lens 1126, which is a projection optical system, and the image is magnified to be displayed.

Referring to FIG. 12, a laptop personal computer 1200, which is another example of the electronic apparatus, includes a liquid crystal display 1206 including the liquid crystal device 1 accommodated in a top cover case thereof and a main unit 1204 containing a CPU, a memory, a modem, and the like and including a keypad 1202 mounted thereon.

Also, as shown in FIG. 13, one of two transparent substrates 1304a and 1304b constituting a liquid crystal device substrate 1304 is connected to a tape carrier package (TCP) 1320 including an IC chip 1324 mounted on polyimide tape 1322 provided with a metal transparent conductive film. Such a device arranged as described above can be manufactured, sold, and used as a liquid crystal device functioning as a component of the electronic apparatus.

As described above, in addition to the electronic apparatus described above with reference to FIGS. 11 to 13, a liquid crystal television set, a view-finder type or monitor direct-view type video tape recorder, a car navigation system, an electronic notebook, a calculator, a word processor, a workstation, a mobile telephone, a television telephone, a POS terminal, a device provided with a touch panel, and the like are examples of the electronic apparatus shown in FIG. 10.

The present invention is not limited to the exemplary embodiments described above. Various changes and modifications may be made to the present invention without departing from the gist or spirit of the present invention. An electro-optical device, a driving circuit of the electro-optical device, and an electronic apparatus to which such changes and modifications are made are also included within the technical scope of the present invention.

What is claimed is:

1. An electro-optical panel driving circuit, comprising:
a substrate;
pixel electrodes provided above the substrate;
switching elements that switch on and off the corresponding pixel electrodes;
data lines that supply image signals to the corresponding pixel electrodes via the corresponding switching elements;
a shift register circuit that sequentially outputs transfer signals;
a buffer circuit that buffers the sequentially output transfer signals;
a sampling circuit that samples the image signals using the buffered transfer signals as sampling pulses and that supplies the sampled image signals to the corresponding data lines; and
a dummy circuit that simulates at least part of the buffer circuit and the sampling circuit,
delay signals indicating the amount of delay of the sampling pulses and generated by the dummy circuit being fed back to the shift register circuit so that the amount of delay is reduced, and
the buffer circuit, the sampling circuit, and the dummy circuit provided on the substrate.

2. The electro-optical panel driving circuit according to claim 1, the shift register circuit provided in an integrated circuit externally attached to the substrate.

3. The electro-optical panel driving circuit according to claim 1, the buffer circuit including a plurality of stages of buffers connected in series,
the sampling circuit including analog sampling switches, and
the dummy circuit simulates at least the buffer in the final stage among the plurality of stages of buffers.

4. The electro-optical panel driving circuit according to claim 3, the dummy circuit simulates the sampling switches and all of the plurality of stages of buffers.

5. The electro-optical panel driving circuit according to claim 1, semiconductor elements constituting the sampling circuit formed in the same process and at the same time as semiconductor elements constituting the corresponding dummy circuit.

6. The electro-optical panel driving circuit according to claim 5, each of the semiconductor elements is an N-type semiconductor element.

7. The electro-optical panel driving circuit according to claim 5, further comprising:
a timing adjusting circuit, each of the semiconductor elements being a thin-film transistor,
the source of the thin-film transistor connected to a low-potential power supply of the driving circuit and the drain of the thin-film transistor biased at a high-potential power supply of the driving circuit and connected to a detection terminal of the driving circuit,
the shift register circuit sequentially outputting the transfer signals in accordance with a clock cycle of clock signals, and
the timing adjusting circuit adjusting the timing of the clock signals input to the shift register circuit on the basis of the timing of the falling edge of the delay signals detected by the detection terminal.

8. The electro-optical panel driving circuit according to claim 1, further comprising:
a timing adjusting circuit,
the shift register circuit sequentially outputting the transfer signals in accordance with a clock cycle of clock signals, and
the timing adjusting circuit adjusting the timing of the clock signals input to the shift register circuit on the basis of the amount of delay indicated by the delay signals.

9. The electro-optical panel driving circuit according to claim 8, the shift register circuit and the timing adjusting circuit provided in an integrated circuit externally attached to the substrate.

10. The electro-optical panel driving circuit according to claim 1, the channel width of first thin-film transistors constituting the sampling circuit equal to the channel width of second thin-film transistors constituting the dummy circuit, the second thin-film transistors corresponding to the first thin-film transistors.

11. The electro-optical panel driving circuit according to claim 1, the channel width of second thin-film transistors constituting the dummy circuit, the second thin-film transistors corresponding to first thin-film transistors constituting the sampling circuit, being smaller than or equal to the channel width of the first thin-film transistors, and
the ratio of the size of the first thin-film transistors to the size of a first buffer circuit in the preceding stage of the first thin-film transistors being equal to the ratio of the size of the second thin-film transistors of the dummy circuit to the size of a second buffer circuit in the preceding stage of the second thin-film transistors.

12. The electro-optical panel driving circuit according to claim 1, the buffer circuit including a plurality of stages of buffers connected in series,
the sampling circuit including analog sampling switches,
the channel width of second thin-film transistors constituting the dummy circuit, the second thin-film transistors corresponding to first thin-film transistors functioning as the sampling switches, being smaller than or equal to the channel width of the first thin-film transistors, and
the ratio of the size of the first thin-film transistors to the size of the buffer in the final stage of the first buffer circuit in the preceding stage of the first thin-film transistors being equal to the ratio of the size of the second thin-film transistors of the dummy circuit to the size of the buffer in the final stage of a second buffer circuit in the preceding stage of the second thin-film transistors.

13. An electro-optical device comprising the electro-optical panel driving circuit as set forth in claim 1 and the electro-optical panel driven by the driving circuit.

14. An electronic apparatus, comprising:
the electro-optical device as set forth in claim 13.
